(19) United States
(12) Patent Application Publication
(10) Pub. No.: US 2006/0283400 A1
(43) Pub. Date: Dec. 21, 2006

(54) Domestic pet collar and leash

(76) Inventor: Carlo Liconti, Toronto (CA)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/156,421

(22) Filed: Jun. 20, 2005

(51) Int. Cl. A01K 27/00

(52) U.S. Cl. 119/858

(57) ABSTRACT

A dog collar or leash has a first elongate section defining a cavity for receiving bags therein and a second elongate section. At least a portion of the second elongate section is releasably engageable with the first elongate section for enclosing the cavity when engaged and for opening the cavity when released. The leash also has an outlet in communication with the cavity, for exposing at least a portion of one of the bags. At least a portion of the second elongate section is released from engagement with the first elongate section for loading the bags in the cavity.

### FIELD OF THE INVENTION

This invention relates to collars and leashes for domestic pets and in particular to a dog collar or leash having structure for carrying bags for disposal of dog excrement.

### BACKGROUND OF THE INVENTION

In recent years it has become commonplace for dog owners to pick up excrement left by their dogs. Indeed, many jurisdictions have now made this mandatory. In order to do this, many dog owners and dog walkers carry plastic bags such as grocery bags in their pockets so that the excrement can be picked up in the plastic bag and disposed of in a garbage container in a sanitary manner. Clearly, this method of disposal requires the dog owner to collect and carry plastic bags prior to taking the dog outside. While this method is commonly used, it suffers many problems. One such problem is that preparation is required, including looking for and storing plastic bags in advance of taking the dog outside. This added inconvenience discourages people from picking up after their dogs.

Another problem is that the use of grocery bags requires the collection of plastic grocery bags that the dog owner or dog walker may not have available. Also, the dog owner may not have pockets available for carrying the bags. Thus, the bags are carried by hand or even tied to the leash, which requires further preparation prior to walking. Furthermore, more bags may be required than the dog owner carries or the dog owner may be required to hold on to a partially filled bag in case further use of the bag is required. This is clearly an unpleasant task and is somewhat embarrassing.

Accordingly, it is an object of an aspect of the present invention to provide an apparatus for carrying and dispensing bags suitable for disposal of dog excrement.

### SUMMARY OF THE INVENTION

In an aspect of the present invention there is provided a domestic pet collar. The collar has a first elongate section defining a cavity for receiving bags therein, and a second elongate section. At least a portion of the second elongate section is releasably engageable with the first elongate section for enclosing the cavity when engaged and for opening the cavity when released. At least one of the first and second sections have a first end and at least one of the first and second sections have a second end. The first end and the second end are releasably engageable to form a collar loop. The collar also has an outlet in communication with the cavity, for exposing at least a portion of one of the bags. At least a portion of the second elongate section is released from engagement with the first elongate section for loading the bags in the cavity.

In another aspect, there is provided a domestic pet leash. The pet leash has a first elongate section defining a cavity for receiving bags therein, and a second elongate section. At least a portion of the second elongate section is releasably engageable with the first elongate section for enclosing the cavity when engaged and for opening the cavity when released. The leash also has an outlet in communication with the cavity, for exposing at least a portion of one of the bags. At least a portion of the second elongate section is released from engagement with the first elongate section for loading the bags in the cavity.

In yet another aspect, there is provided a cue of indexable bags for use with a dog collar or leash having a first elongate section defining a cavity for receiving the bags therein, a second elongate section, at least a portion of the second elongate section being releasably engageable with the first elongate section for enclosing the cavity when engaged and for opening the cavity when released, and an outlet in communication with the cavity, for exposing at least a portion of one of the bags, whereby the at least a portion of the second elongate section is released from engagement with the first elongate portion for loading the bags in the cavity. The cue of indexable bags includes a series of folded bags. Each of the bags is releasably attached to an adjacent bag in the series and each of the bags has a tab for pulling the bags from outlet.

Advantageously, bags suitable for disposal of dog excrement are provided in the collar or leash which are used when walking the dog. Several bags can be stowed in the collar such that reloading of the collar is infrequent. Thus, little preparation is typically required prior to walking the dog. Bags can be individually pulled from the collar or leash for use and are easily accessible and readily available when needed. Furthermore, the collar or leash provide convenient storage of the bags, leaving the dog walkers hands or pockets free of bags. In a further advantage, the dog carries the bags in the collar according to one embodiment of the invention.

### BRIEF DESCRIPTION OF THE DRAWINGS

The invention will be better understood with reference to the drawings, and the following description, in which:

FIG. 1 is a perspective view of a dog collar according to an aspect of an embodiment of the present invention;

FIG. 2 is a sectional view of a portion of the dog collar along line 2-2 of FIG. 1;

FIG. 3 is a sectional view of a portion of the dog collar along line 3-3 of FIG. 1;

FIG. 4 is a sectional view of the portion of the dog collar of FIG. 3, with a portion of a second elongate section released from engagement with a first elongate section;

FIG. 5 is a view of a portion of the dog collar of FIG. 1, shown with a portion of the second elongate section released from engagement with a first elongate section and shown in a flat orientation;

FIG. 6 is a view of an individual folded bag for use with the dog collar of FIG. 1;

FIG. 7 is a view of a portion of the dog collar of FIG. 1, showing a bag being pulled from the collar; and

FIG. 8 is a perspective view of a dog leash according to an aspect of an alternative embodiment of the present invention.

### DETAILED DESCRIPTION OF THE PREFERRED EMBODIMENTS

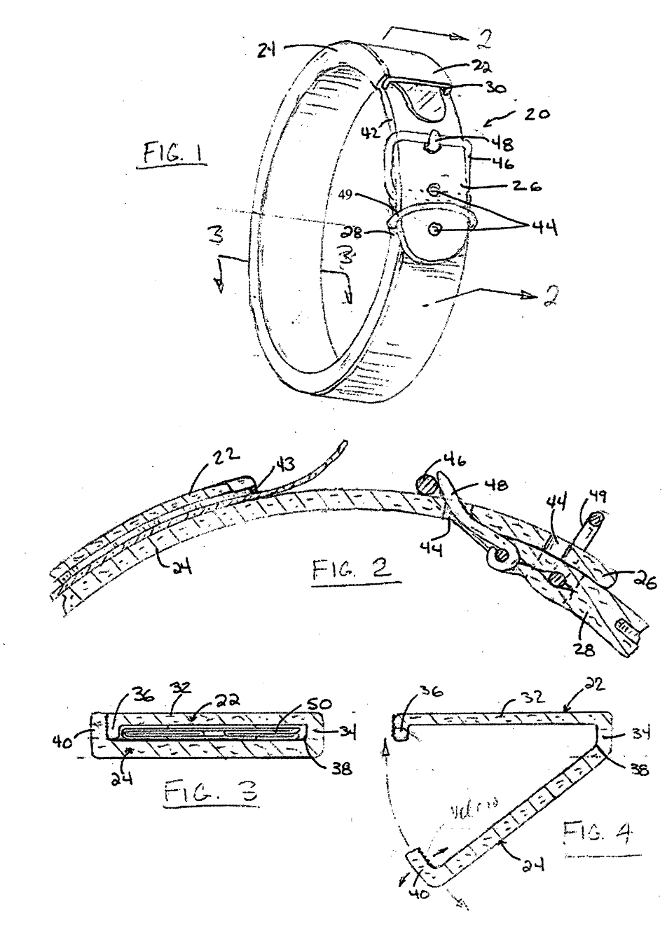

Reference is first made to FIG. 1 to describe a dog collar in accordance with an embodiment of the present invention and indicated generally by the numeral 20. The dog collar 20 includes a first elongate section 22 defining a cavity for receiving bags therein. At least a portion of a second elongate section 24 is releasably engageable with the first elongate section 22 for enclosing the cavity when engaged and for opening the cavity when released. The second elongate section 24 has a first end 26 and the first and second elongate sections 22, 24, respectively have a second end 28. The second end 28 is releasably engageable with the first end 26 to form a collar loop. An outlet 30 communicates with the cavity, for exposing at least a portion of one of the bags. At least a portion of the second elongate section 24 is released from engagement with the first elongate section 22 for loading the bags in the cavity.

The dog collar 20 will now be described in more detail. As shown in FIGS. 1 to 4, the first elongate section 22 is generally u-shaped to form the cavity defined by the center wall 32 and the side walls 34, 36 of the u-shaped section. In the present embodiment, the side wall 34 is attached to the second elongate section 22 along a fold line 38 and is moveable between a closed position, shown in FIGS. 1, 2 and 3 and an open position, shown in FIG. 4. The second elongate section 22 includes a lip 40 which overlaps with the side wall 36 and releasably engages therewith when the first and second elongate section 22, 24, respectively, are in the closed position. In the present embodiment, the lip 40 and the side wall 36 have a hook and loop fastener disposed on complementary sides thereof for releasable engagement.

The first section 34 and second section 36 are unitary molded plastic and are biased to the open position such that the first section 34 and second section 36 open to expose the cavity when the releasable fastener is not engaged.

Reference is now made to FIGS. 1 and 2. The first section 22 and the second section 24 together enclose the cavity which extends through a majority of the collar 20. The first section 22 and the lip 40 of the second section 24 terminate proximal a first end 26 of the collar. A remaining portion 42 of the second section 24 extends beyond the end of the first section 22 and the lip 40 to define the first end 26 of the collar 20. Clearly, the cavity is exposed at the outlet 30 which is defined by the end of the first section 22 and the lip 40.

The first section 22 includes a pair of shoulders 43 that extend from an interior surface of the first section 22, proximal the outlet 30 and into the cavity.

The remaining portion 42 of the second section 24 includes a series of longitudinally spaced sizing holes 44 that are generally centrally disposed along the length thereof for receiving a catch rod of a buckle.

At the opposing second end 28 of the collar 20, the first section 22 and second section 24 are joined together on either side of a buckle 46 to retain the buckle 46 and catch rod 48. The buckle 46 and catch rod 48 are configured to cooperate with the first end 26 of the collar 20 and the sizing holes 44. When the buckle 46 and catch rod 48 engage with the first end 26 and one of the sizing holes 44, the first and second sections 22, 24, respectively, form a collar loop. The second end 28 also includes a loop 49 for retaining the first end 26 of the collar in a position generally adjacent the second end 24 and in a generally circular configuration. It will be appreciated that the collar loop is fitted to a dog using the appropriate sizing hole.

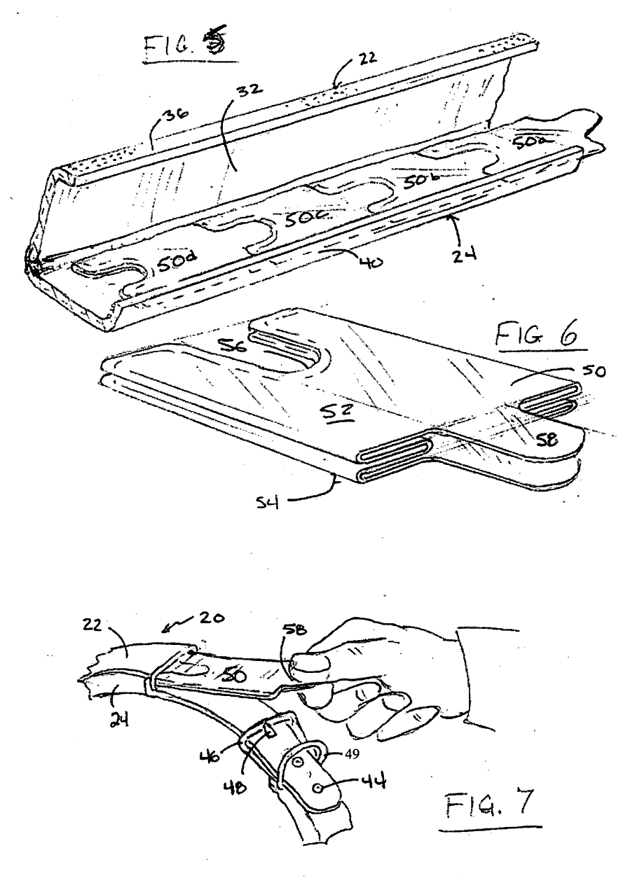

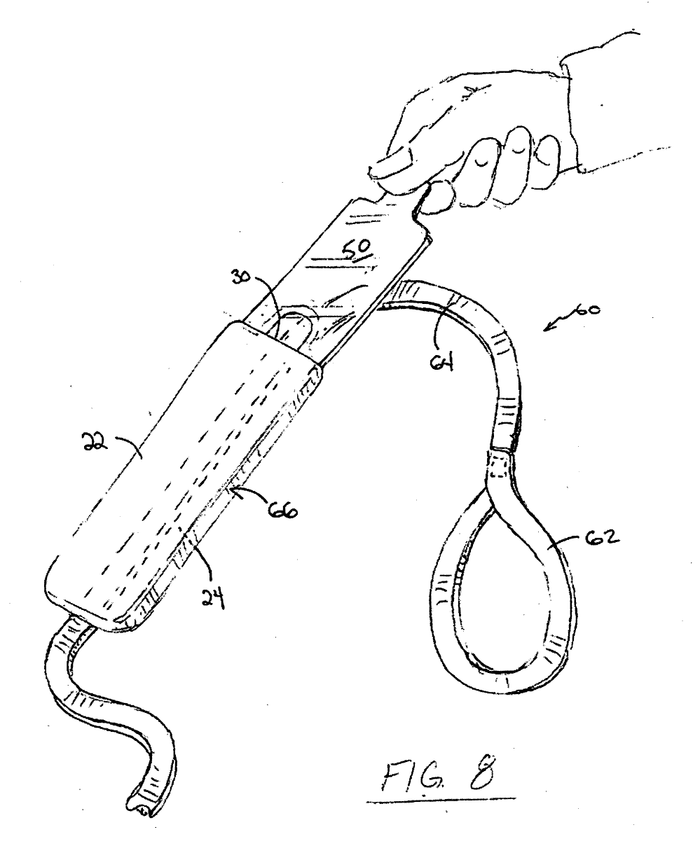

Reference is now made to FIGS. 5 and 6 to describe a bag 50 for use with the collar 20. A cue of bags designated by the numerals 50a, 50b, 50c and 50d in FIG. 5, are received in the cavity of the collar 20. Each bag 50 is folded such that portions of the sides of the bag are folded between a first surface 52 and a second surface 54. The rear of the bag 50 is also folded and configured to include an arched recess 56 generally centrally disposed in the rear of the bag 50. The front of the bag includes a pair of arched tab portions 58 that generally project forward from the remainder of the bag 50. As shown in FIG. 5, the rear of the bag 50 is complementary to the front of the bag 50 such that the arched tab portions 58 of the bags are received in the arched recess 56 of the rear of the bag 50.

The rear of each bag 50 is joined to the front of the following bag 50 in the cue and is separated from the following bag 50 by perforations. After separation of the first bag 50a in the cue, the bag 50a is then unfolded for use.

Clearly the cue of bags is shaped and configured to fit into the cavity in the collar 20. Also, the tab portions 58 of the first bag 50a extend from the outlet 30 of the cavity.

The use of the collar 20 will now be described with reference to FIGS. 1 and 7. If no bags are present in the collar, the first section 22 and second section 24 are disengaged causing the first and second sections 22, 24, respectively, to open, thereby exposing the cavity. With the cavity exposed, a cue of bags is placed in the cavity such that the tab portions 58 of the first bag 50a in the cue project from the outlet 30 of the cavity. The second section 24 is then urged back into engagement with the first section 22 to enclose the cavity. The hook and loop fastener on the side portion 36 and the lip 40 maintain the first and second sections 22, 24, respectively, in the closed position.

The collar 20 is then placed around the neck of a dog, closing the loop, inserting the first end 26 through the buckle and inserting the catch rod 48 of the buckle 46 into the appropriate one of the sizing holes 44. The first end is also inserted through the loop 49 to retain the first end 26 in a generally circular configuration for aesthetic purposes.

When in use, the first bag 50a in the cue is pulled by grasping the tab portions 58 and pulling the bag 50a away from the collar 20 and out of the outlet 30. The remaining bags 50b, 50c and 50d are pulled in the cavity toward the outlet 30 until the shoulders 43 slide into perforations between the first bag 50a and the second bag 50b. Continued pulling of the bag 50a away from the collar 20 then causes separation of the first and second bags 50a and 50b, respectively. The first bag 50a is then unfolded for use. Clearly, the second bag 50b is now the first bag in the cue and is disposed in the cavity such that the tab portions 58 project from the outlet 30, ready to be grasped and pulled for use.

To remove the collar 20 from the dog, the first end 26 is removed from the loop 49 and from the buckle 46, urging the catch rod 48 out of the sizing hole 44. The collar 20 can then be removed from the neck of the dog and bags 50 can then be reloaded in the collar 20.

FIG. 8 shows a dog leash according to an alternative embodiment of the present invention and indicated generally by the numeral 60. In the present embodiment, the dog leash 60 includes a handle portion 62 and an elongate central section 64 extending from the handle portion and a bag holding portion 66 fixed to the central section 64. Clearly, the bag holding portion includes a first elongate section 22 that defines a cavity for receiving bags and a second elongate section 24. The second elongate section 24 is releasably engageable with the first elongate section 22, as described in detail in the above-described embodiment. As in the above-described embodiment, an outlet 30 in communication with the cavity, is provided for exposing at least a portion of the bag 50. The details and structure of the bag holding portion will be understood from the above-described collar-embodiment and need not be further described herein. In the present embodiment, the second elongate section 24 of the bag holding portion 66 is fixed to the elongate central section 64. In an alternative embodiment, the second elongate section 24 is removably engageable with the elongate central section 64.

Several modifications and changes may occur to those skilled in the art. For example, the size and shape of many of the features can vary while still performing the same function. Alternative materials and alternative joining methods can be used. Clearly the first section 22 and second section 24 need not be a unitary piece, the first and second sections, 22, 24, respectively can be hinged along the line 38 or can be releasably engaged on both sides. Also, the first and second sections 22, 24, respectively, need not be releasably engageable by a hook and loop fastener. Other releasable fasteners can be used. Also, these two sections may simply include interlocking parts such as teeth or may engage by a friction fit. The first and second sections need not be a molded plastic, but can be any suitable collar material for the present application. The ends of the collar can be releasably connectable using any suitable connection such as, for example, a clasp. More than four bags can be loaded in a cue in the collar. Shoulders are not necessary to retain a remainder of the bags in the collar when a first bag in the cue is removed. Other retaining means can be used, for example, the cavity size can be slightly reduced at the outlet, introducing friction between the bags and the first and second sections, sufficient to cause separation of the first and second bags when the first bag is pulled out. Other variations and modifications will occur to those of skill in the art. All such modifications and variations are considered to be within the sphere and scope of the invention.

What is claimed is:

1. A domestic pet collar comprising:
a first elongate section defining a cavity for receiving bags therein;
a second elongate section, at least a portion of the second elongate section being releasably engageable with the first elongate section for enclosing the cavity when engaged and for opening the cavity when released, at least one of the first and second sections having a first end and at least one of the first and second sections having a second end, the first end and the second end being releasably engageable to form a collar loop; and
an outlet in communication with the cavity, for exposing at least a portion of one of the bags,
whereby the at least a portion of the second elongate section is releasable from engagement with the first elongate section for loading the bags in the cavity.

2. The domestic pet collar according to claim 1, wherein the first and the second sections are unitary such that the second section is foldable to enclose the cavity.

3. The domestic pet collar according to claim 1, wherein the first section is hinged to the second section.

4. The domestic pet leash according to claim 1, wherein the first and second sections are two separable components, the first section having first and second sides releasably engageable with first and second sides, respectively, of the second section.

5. The domestic pet collar according to claim 3, wherein a side portion of the second section is releasably engageable with a side portion of the first section by a releasable fastener.

6. The domestic pet collar according to claim 1, further comprising a cue of folded bags in the cavity.

7. The domestic pet collar according to claim 6, wherein the bags are releasably connected together in the cue by perforations.

8. The domestic pet collar according to claim 6 wherein each of the bags has a tab portion extending from the outlet for grasping.

9. The domestic pet collar according to claim 1, further comprising a bag retainer means proximal the outlet for resisting removal of a second bag in a cue when a first bag in the cue is removed from the cavity.

10. The domestic pet collar according to claim 9 wherein the bag retainer means comprises a pair of shoulders proximal the outlet.

11. A domestic pet collar or leash having a bag-holding portion comprising:
a first elongate section defining a cavity for receiving bags therein;
a second elongate section, at least a portion of the second elongate section being releasably engageable with the first elongate section for enclosing the cavity when engaged and for opening the cavity when released; and
an outlet in communication with the cavity, for exposing at least a portion of one of the bags,
whereby the at least a portion of the second elongate section is releasable from engagement with the first elongate section for loading the bags in the cavity.

12. The domestic pet collar or leash according to claim 11, wherein the first section is hinged to the second section.

13. The domestic pet collar or leash according to claim 12, wherein a side portion of the second section is releasably engageable with a side portion of the first section by a releasable fastener.

14. The domestic pet collar or leash according to claim 13, wherein the first and second sections are two separable components, the first section having first and second sides releasably engageable with first and second sides, respectively, of the second section.

15. The domestic pet collar or leash according to claim 11, further comprising a cue of folded bags in the cavity.

16. The domestic pet collar or leash according to claim 15, wherein the bags are releasably connected together in the cue by perforations.

17. The domestic pet collar or leash according to claim 15 wherein each of the bags has a tab portion extending from the outlet for grasping.

18. The domestic pet collar or leash according to claim 11, further comprising a bag retainer means proximal the outlet for resisting removal of a second bag in a cue when a first bag in the cue is removed from the cavity.

19. The domestic pet collar or leash according to claim 18 wherein the bag retainer means comprises a pair of shoulders proximal the outlet.

20. A cue of indexable bags for use with a dog collar or leash having a first elongate section defining a cavity for receiving the bags therein, a second elongate section, at least a portion of the second elongate section being releasably engageable with the first elongate section for enclosing the cavity when engaged and for opening the cavity when released, and an outlet in communication with the cavity, for exposing at least a portion of one of the bags, whereby the at least a portion of the second elongate section is released from engagement with the first elongate portion for loading the bags in the cavity, the cue comprising a series of folded bags, each of the bags being releasably attached to an adjacent bag in the series and each of the bags having a tab for pulling the bags from outlet.
